(19) United States
(12) Patent Application Publication
(10) Pub. No.: US 2004/0036933 A1
(43) Pub. Date: Feb. 26, 2004

(54) Planar holographic multiplexer/demultiplexer

(75) Inventors: Vladimir Yankov, Washington TWP, NJ (US); Igor Ivonine, Uppsala (SE); Andrei Talapov, Tenafly, NJ (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Vyoptics, Inc., Allendale, NJ

(21) Appl. No.: 10/405,160

(22) Filed: Apr. 2, 2003

Related U.S. Application Data
(63) Continuation of application No. 09/842,065, filed on Apr. 26, 2001, now abandoned.

(51) Int. Cl. G03H 1/00

(52) U.S. Cl. 359/34

(57) ABSTRACT

A method and device provide efficient wavelength division multiplexing/demultiplexing (WDM) including reduced signal distortion, higher wavelength selectivity, increased light efficiency, reduced cross-talk, and easier integration with other planar devices, and lower cost manufacturing. The method and device include a planar holographic multiplexer/demultiplexer having a planar waveguide, the planar waveguide including a holographic element that separates and combines pre-determined (pre-selected) light wavelengths. The holographic element includes a plurality of holograms that reflect pre-determined light wavelengths from an incoming optical beam to a plurality of different focal points, each pre-determined wavelength representing the center wavelength of a distinct channel. Advantageously, a plurality of superposed holograms may be formed by a plurality of structures, each hologram reflecting a distinct center wavelength to represent a distinct channel to provide discrete disperstion. When used as a demultiplexer, the holographic element spatially separates light of different wavelengths and when reversing the direction of light propagation, the holographic element may be used as a multiplexer to focus several optical beams having different wavelengths into a single beam containing all of the different wavelengths.

### CROSS REFERENCE TO RELATED APPLICATIONS

The U.S. patent application Ser. No. 09/678,052, entitled “A Holographic Multiplexer/Demultiplexer and Wavelength Exchanger”, is expressly incorporated herein by reference.

### FIELD OF THE INVENTION

The present invention generally relates to optical communications and optical transmission systems.

### BACKGROUND INFORMATION

The need frequently arises for communications systems which simultaneously convey multiple messages from a large number of information sources in one location to a large number of users at another location. Multiplexing systems economically meet this need by combining the messages from several information sources, which are then transmitted as a composite group over a single transmission facility, with provision at the receiver for separation (demultiplexing) back to the individual messages. Each of the individual streams of information that form a multiplexed group are often denoted as a channel. Thus, a primary advantage of multiplexing systems is a reduction of required equipment resources, which thereby reduces infrastructure costs.

Frequency division multiplexing (FDM) and time division multiplexing (TDM) are often used for electronic communications systems. Until recent years, these techniques were also used for optical communications systems, which reduced transmission efficiency since optical signals had to be converted to electrical signals to perform these multiplexing techniques.

In recent years, however, wavelength division multiplexing (WDM) has been implemented to increase the capacity of optical communications systems by simultaneously operating at more than one wavelength. In WDM, each discrete data channel is modulated onto an optical carrier of a fixed wavelength, and then all of the individual carriers are superimposed onto the optical transmission medium (multiplexing). At the optical receiving end, each of the individual carriers is re-established by separating (demultiplexing) the composite carrier into its individual wavelength components and delivering them to individual end users. Additionally, at the optical receiving end, the process of multiplexing may be performed to combine the individual wavelength components (each carrying user data) received from the different end users, and convey them along the optical transmission medium (in a single optical beam) to another destination. Generally, a demultiplexer requires more elaborate design than a multiplexer, and may provide dual (reversible) functionality as both a demultiplexer and a multiplexer by changing the direction of light propagation through the device.

Currently, a number of different WDM multiplexer/demultiplexers are used including diffraction gratings, Fiber Bragg Grating filters (FBG), thin-films interference filters, array-waveguide gratings (AWG), Mach-Zehnder interferometers, acoustooptic filters, and other devices. Some devices, including the thin-film interference filters and FBG, provide good wavelength selectivity, but have high manufacturing costs. Other devices, including the AWG and planar etched gratings, use a planar incidence of light setup (plane of grating is parallel to direction of light propagation), and thereby, may be easier to manufacture in large volumes, but have low wavelength selectivity (e.g., non-rectangular shape of selectivity curve), and low light efficiency (percentage of received light energy to incident light energy is significantly less than 100%).

Additionally, a holographic plate that contains a fringe pattern corresponding to the interference produced by a combination of coherent light sources can function as an optical multiplexer/demultiplexer. When a source radiates multiple wavelengths of light directed to such a holographic plate, the component wavelengths are separated. Each wavelength is focused to a pre-selected focal point, which is determined by the configuration of the fringes contained in the holographic plate.

U.S. Pat. No. 4,359,259 to Homer et al. and U.S. Pat. No. 4,357,955 to Ludman et al. disclose using a holographic plate as a multiplexer/demultiplexer. In each of these patents, the holographic plate contains an interference pattern created using a single wavelength of light. When such a holographic plate is used as a demultiplexer, the separated wavelengths are focused close together approximately along a straight line.

It has been shown that a holographic recording medium can store multiple images. Moreover, if the recording medium is appropriately sensitive to a range of wavelengths, it is possible to record not only multiple objects, but also multiple wavelengths. As an illustrative example, blue, yellow and red coherent light sources may be used to record a ball, a pen and a card respectively. If upon recording, the corresponding reference yellow light source is directed to the holographic plate, an image of a yellow pen will be generated, and importantly, a yellow ball or card of the same quality will not be generated. The images are superposed in the medium and, again to a first approximation, act independently with respect to one another. There are limitations on the ability of a holographic medium to store independent, superposed images imposed by the diffraction efficiency related to the optical properties of the medium (e.g., thickness (d), refractive index (n)).

One of the main objectives of demultiplexing, and in using a holographic plate as a demultiplexing device in particular, is to place tips of optical fibers in locations where they can receive a certain threshold of light intensity of a specific, pre-selected wavelength. As noted above, a properly fabricated holographic plate can focus the different wavelengths emanating from a source at separate locations, and when used in a reversed configuration, the plate can be used as a multiplexer to focus separate wavelengths from different locations at a single point.

Cross-talk presents a significant impediment to performing multiplexing and demultiplexing. Cross-talk occurs when resonance points for different wavelengths coincide closely in location. If there is a high degree of cross-talking, optical fibers receive a light intensity above a certain threshold at two or more wavelengths, in effect defeating the purpose of demultiplexing, which is to separate light of different wavelengths.

As previously noted, existing WDM devices (including holographic techniques) are deficient in that they provide limited wavelength selectivity, reduced light efficiency, continuous dispersion leading to greater signal distortion, co-channel interference (cross-talk), and manufacturing complexity (e.g., multiple number of holographic elements) leading to higher costs.

### SUMMARY OF THE INVENTION

The present invention provides a method and device for performing optical multiplexing and demultiplexing utilizing a planar waveguide and incorporating a holographic element written with multiple holograms, each hologram reflecting a pre-determined wavelength of light. The WDM device provides reduced signal distortion, higher wavelength selectivity, increased light efficiency, reduced cross-talk, and easier (lower cost) manufacturing than conventional devices.

The holographic element includes a plurality of wavelength-selective holograms that reflect pre-determined light wavelengths from an incoming optical beam to a plurality of different focal points, each pre-determined wavelength representing the center wavelength of a distinct communications channel.

Each wavelength-selective hologram includes a large number of weakly reflecting structures, periodically or quasi-periodically placed in the planar waveguide, to provide constructive interference only for the light waves belonging to one communication channel. The long path of light in the planar holographic element allows use of the weakly reflecting structures to provide narrow optical channel widths, which are necessary for use in WDM.

The holograms may be written using a number of methods which include writing by interference pattern of two coherent radiation beams writing by focused beam of some kind of radiation, various lithographic or micro-technology methods.

Bi-level (binary) computer-generated holograms, consisting of dash or dot structures, and created by lithographic methods, may be especially suitable for manufacturing.

Use of holographic structures arranged in elliptical patterns adds focusing abilities to the holographic element, avoiding the need for additional lenses, and thus simplifying the demultiplexer design.

When used as a demultiplexer, the holographic element spatially separates light of different wavelengths into a plurality of output optical beams. Advantageously, the different wavelengths may be focused to focal points lying on a single line similar to existing demultiplexers that use continuous dispersion, or may be focused to focal points lying anywhere in a two-dimensional plane that takes advantageous of the discrete dispersion used by the present invention. When reversing the direction of light to propagation, the holographic element may be used as a multiplexer to focus several optical beams having different wavelengths into a single beam containing all of the different wavelengths.

According to one embodiment the WDM device may be integrated into a photonic integrated circuit.

### BRIEF DESCRIPTION OF THE DRAWINGS

FIG. 1 is a block diagram of a holographic multiplexer/demultiplexer in accordance with an embodiment of the present invention.

FIG. 2 is an illustration showing a cross-section of a holographic multiplexer/demultiplexer in accordance with an embodiment of the present invention.

FIG. 3 is a block diagram of a holographic multiplexer/demultiplexer in accordance with an alternative embodiment of the present invention.

FIG. 4 is an illustration showing a relationship between a hologram wave vector and incoming and outgoing optical beam wave vectors in accordance with an embodiment of the present invention.

FIG. 5 is an illustration showing a relationship between a hologram wave vector and wave vectors for writing optical beams in accordance with an embodiment of the present invention.

FIG. 6 is an illustration of a periodic thickness modulation for a hologram in accordance with an embodiment of the present invention.

FIG. 7 is an illustration of a planar hologram in accordance with another alternative embodiment of the present invention.

FIG. 8 is an illustration of discrete dispersion produced by a holographic multiplexer/demultiplexer in accordance with an embodiment of the present invention.

### DETAILED DESCRIPTION

In accordance with the present invention, a planar waveguide includes a holographic element used as a multiplexer/demultiplexer (e.g., WDM). The holographic element includes a plurality of holograms, formed by a plurality of structures, that may be written either as an interference pattern of different kinds of radiation or by lithography. Advantageously, the plurality of holograms form a plurality of superposed holograms, where each hologram is a two-dimensional planar hologram (or planar waveguide hologram) and each hologram reflects a pre-determined wavelength (a center wavelength) from an incoming optical beam to represent a distinct channel.

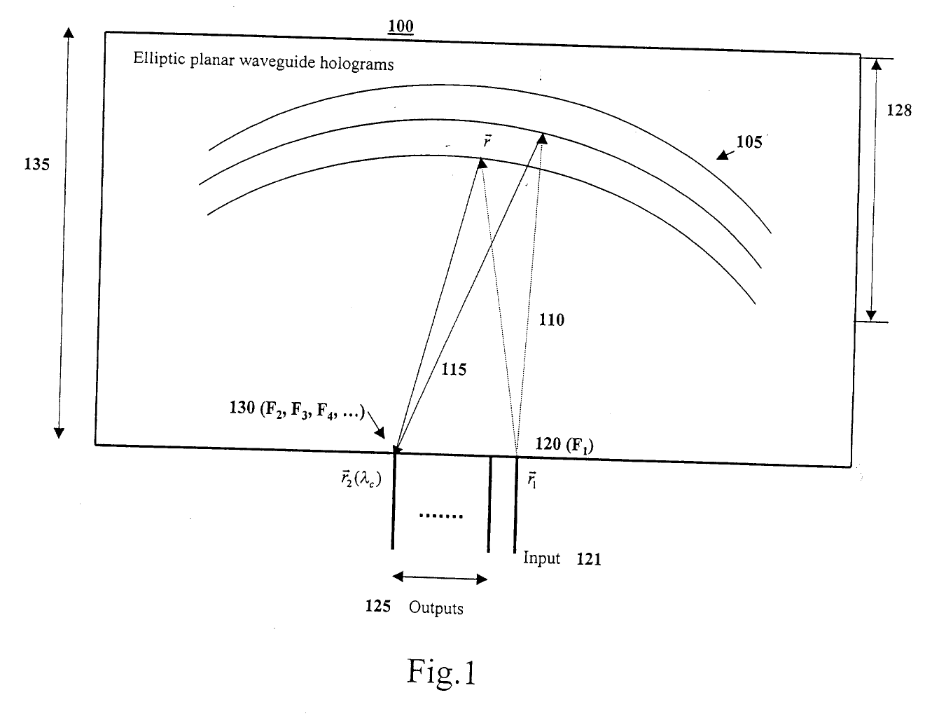

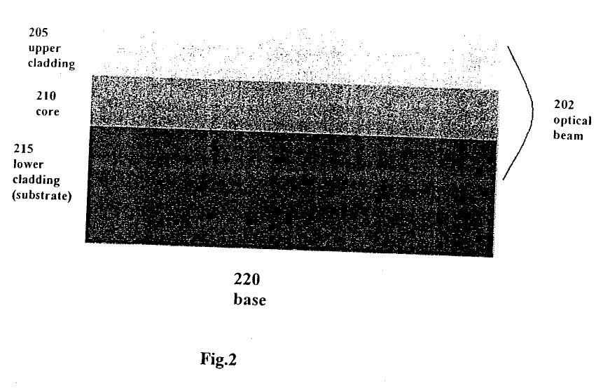

A structure of an embodiment of the present invention is shown in FIG. 1 and FIG. 2. A waveguide (X-Y) plane structure is shown in FIG. 1. A representative cross-section of the planar holographic multiplexer/demultiplexer, which may be created by lithography, for example, in accordance with embodiments of the present invention, is shown in FIG. 2. The planar holographic multiplexer/demultiplexer comprises a planar waveguide slab 200 (e.g., flat sandwich) including a base 220, substrate layer (lower cladding layer) 215, core 210, and upper cladding layer 205. A representative wavefront for an optical beam 202 as it enters or exits from the waveguide 200 is also shown in FIG. 2. The base 220 provides support for the waveguide, and the planar waveguide slab 200 may include additional substrate layers. Advantageously, the planar waveguide 200 is a single-mode or multi-mode waveguide slab that propagates an optical (light) beam 202 primarily within the core 210 as confined by the substrate and cladding layers 205, 215. As shown by a representative example in FIG. 2, in a three-dimensional coordinate system where the z-axis is in the direction of cladding/core depth, the light beam 202 may propagate in the x-y plane. Also, some portions of the optical beam 202 may also propagate in the substrate and/or cladding layers 205, 215. Structures may be written into the slab 200 anywhere (in the same plane) where the optical beam 202 propagates to produce efficient wavelength multiplexing/demultiplexing including any portion of the core, cladding, and/or substrate layers 205, 210, 215 of the planar waveguide slab 200. FIG. 2 may be viewed as a representative (exemplary or symbolic) structure for the planar holographic multiplexer/demultiplexer that allows for flexible control of optical beam propagation. Instead of being forced to exclusively change a geometric waveguide parameter such as thickness to control optical beam propagation, one can effectively change any waveguide parameter, such as refraction index, to control optical beam propagation. The “effective” change of a waveguide parameter, necessary to providing the demultiplexing function, is described below.

FIG. 1 is a block diagram of the planar holographic multiplexer/demultiplexer in accordance with an embodiment of the present invention. The planar holographic multiplexer/demultiplexer 100 includes a planar waveguide 135, the waveguide 135 including a holographic element 128 having structures 105 written into the holographic element 128. Interconnected to the planar waveguide 135 may be an input optical transmission medium 120 and one or more output transmission media 125. Optical transmission media 120, 125 may be an optical fiber, waveguide, or other suitable transmission media for carrying light waves (optical beams). Advantageously, a plurality of superposed, elliptical planar holograms by structures 105 (advantageously elliptical structures) where each hologram represents a set of elliptical structures. Each elliptical structure is a variation of any parameter of the planar waveguide such as the refraction index or thickness of the core or upper cladding, for example. Each set of elliptical structures includes a significant plurality of elliptical structures, and each hologram (set) represents a channel such that the superposition of N holograms forms N channels. The elliptic structures, forming a channel (hologram) with a central wavelength λ_{c}, may be defined in the following way. The variations of a planar waveguide parmeter can be centered on elliptic lines (ellipses). All ellipses of one channel have common focal points, the input focal point 120 with position \vec{r}₁ and the output focal point 130 with position \vec{r}₂ (λ_{c}). The position \vec{r} of each point of one of these ellipses satisfies the following equation:

|\vec{r}−\vec{r}₁|+|\vec{r}−\vec{r}₂(λ_{c})|=m·λ_{c}+C (1)

where the integer m defines one ellipse, C is an arbitrary constant (the same for all ellipses of one hologram), and λ_{c} is the center wavelength for the reflected optical beam that is output at focal point 130. It is well known to those skilled in the art that ellipses focus light (an optical beam), propagating from the one focal point 120, exactly into the second focal point 130, which is schematically shown by light propagation paths 110 and 115 on FIG. 1. Advantageously, the elliptical structures 105 focus light into the second focal point 130 even after multiple reflections to provide reduced (small) signal distortion.

Each elliptical structure may be formed as a variation of any parameter (e.g., optical property) of the planar waveguide including variation of the refractive index or thickness of the core and/or cladding layers of the waveguide. In an exemplary embodiment, each structure may be a hill or a valley (e.g., maxima or minima) of an optical property such as thickness or refractive index of the waveguide.

The holograms may be written on to the core or upper cladding layers 205, 210 of the holographic element as illustrated in FIG. 2.

Advantageously, there may be a multiple number of output focal points 130 (e.g., F₂, F₃, F₄, . . . ), each receiving a different reflected wavelength carried in the input optical beam, and output on transmission media 125. Each hologram 105, representing a distinct channel, will have the same first (input) focal point 120 (F1), and have a different second (output) focal point 130 for a predetermined reflected wavelength. For each hologram 105, the reflected wavelength represents the central wavelength of the channel. In accordance with equation (1), the reflected lightwaves, coming from each elliptical structure forming a single hologram, will constructively interfere at the second focal point 130 producing a resonant reflection condition for that central wavelength. For thick holograms, where the input optical beam travels a long distance in the holographic element and therefore produces a number of reflections, the combination of a plurality of weak reflections of the same central wavelength from each elliptical structure, where each elliptical structure forms one hologram, helps produce this resonant condition. For optimum selectivity, the resonant condition produces increased (nearing 100%) reflectivity for a bandpass region including the central wavelength, and reduced (decreased) reflectivity (nearing 0%) outside of this bandpass region.

The same holographic element 128 may also function as a multiplexer by reversing the direction of light propagation. A plurality of optical bearns, each carrying a different, pre-determined (pre-selected) wavelength, propagate within waveguide 135. The optical beams enter holographic element 128 and strike holograms 105 along one or more propagation paths 115 where this propagation path and other propagation paths originate at focal points 130 upon entering the waveguide 135 from an exit point (tip) of transmission media 125. Upon striking holograms 105, each reflected light wavelength is combined into an output optical beam at focal point 120 (F₁), along one or more propagation paths 110, positioned at an entry point (tip) of transmission medium 120 which can then transmit the output optical beam carrying all the light wavelengths.

Wavelength selectivity for the planar holographic multiplexer/demultiplexer is produced from thick hologram properties. Multiple thick holograms, written into the same physical space, are known in the art to work independently such that the scattering of light by any one hologram does not depend on the presence of other holograms, if the variations of all parameters (e.g., thickness, refractive index, etc.) are weak So advantageously, in accordance with embodiments of the present invention, one hologram represents one channel (e.g., WDM channel).

Properties of elliptic holograms are expected to be very close to the crucial properties of simpler one-dimensional holograms, listed below. The simplest, one-dimensional non-focusing thick hologram, for example a Fiber Bragg Grating, can be described by the following refraction index modulation:

δn(x)=(Δn)·(1+f_{slow}(x)·cos(2·k_{c}·x)) (2)

where f_{slow}(x)(|f_{slow}(x)|≦1) changes significantly on the distances much larger than the light wavelength, and k_{c}=2·π/λ_{c} is the light wave vector value in the middle of the channel passband.

The theory of such holograms is well-known in the art, and provides the following important results:

1) The hologram reflection coefficient at the reflection band (bandpass region) center is given by the following formula

R=tanh²(b/2) (3)

where

$$b = {k}_{c} \cdot \vert \frac{Δ n}{n} \int {f}_{slow} ( x ) ⅆ x \vert \qquad ( 4 )$$

2) When b>>1, the reflection coefficient is very close to 1 not only in the reflection band center, but in the range of the light wavelengths Δλ, defined by the following equation:

$$\frac{Δ λ}{{λ}_{c}} = \frac{Δ n}{n} \qquad ( 5 )$$

where n is the effective refractive index of the waveguide.

3) The shape of selectivity curve outside high reflectivity range strongly depends on the shape of f_{slow}(x), and can be made arbitrary close to ideal rectangular selectivity curve.

These three properties provide high light efficiency and high selectivity of holograms. These properties pertain to not only one-dimentional holograms, but also for two-dimensional planar holograms to provide high light efficiency and high wavelength selectivity for the planar holographic multiplexer/demultiplexer in accordance with embodiments of the present invention.

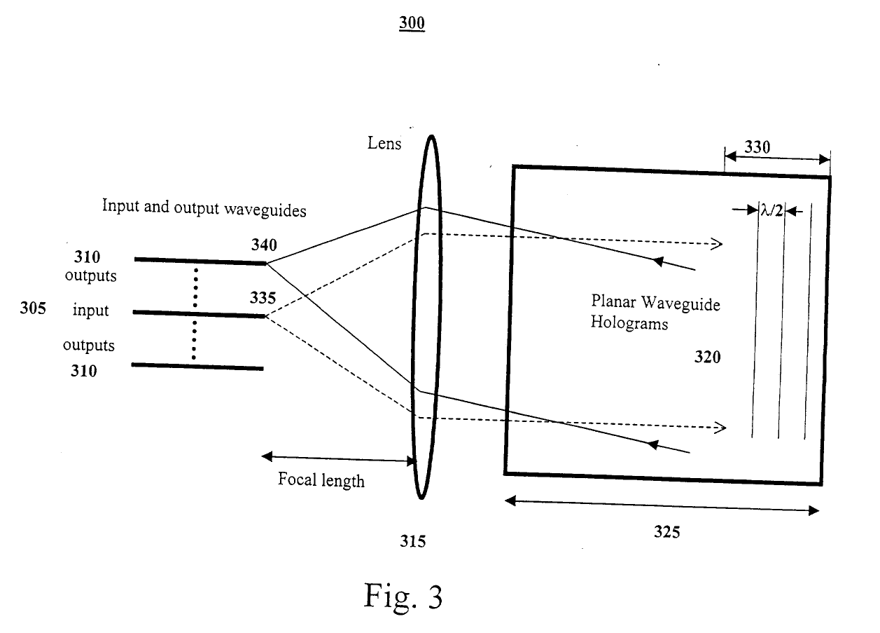

Following equation (2) for one-dimensional thick holograms, another embodiment of the planar holographic multiplexer/demultiplexer may be used. FIG. 3 is a block diagram of the holographic multiplexer/demultiplexer in accordance with an alternative embodiment of the present invention using a two-dimensional analogue of one-dimensional holograms. Similar to FIG. 1, the planar holographic multiplexer/demultiplexer 300 includes a planar waveguide 325, the waveguide 325 including a holographic element 330 having structures 320 written into the holographic element 330. Also, similar to FIG. 1, input optical transmission medium 305 provides an input optical beam from its tip, input focal point 335, to planar waveguide 325, and one or more output transmission media 310 receive one or more pre-determined (pre-selected), reflected light wavelengths from each hologram formed from structures 320.

Different from FIG. 1, the structures 320 in FIG. 3 are not elliptical structures, but straight line structures, advantageously separated by λ/2, to ensure constructive interference at one or more output focal points 340, placed at the entry points (tips) of output transmission media 310. The straight line structures 320 are effectively two-dimensional analogues of a one-dimensional, unfocused hologram. Since these holograms 320 do not have focusing properties, a lens 315 is added, between the planar waveguide 325 and input/output transmission media 305, 310 to transform the divergent input optical beam from the input transmission medium 305 into plane waves and focus the input beam into the planar waveguide 325. Additionally, the lens focuses the reflected wavelengths to their respective focal points 340 along the tips of output transmission media 310. Advantageously, wave vectors of all input light wavelengths are parallel in the region where the holograms are placed. Other aspects of the operation of the planar holographic multiplexer/demultiplexer illustrated in FIG. 3 are the same as FIG. 1 as each hologram reflects a center wavelength of a channel, and the holographic element may be used for both multiplexing and demultiplexing functionality as previously described.

A variety of lens designs may be used for lens 315 shown in FIG. 3. To simplify the planar holographic multiplexer/demultiplexer structure, the lens may be formed in the same planar waveguide layer in which the holograms are formed. One of alternatives is to use so-called GRIN (Graded-Index) lens. Graded index modulation may be generated using, for example, inhomogeneous UV irradiation of Germanium-doped silica planar waveguide, visible light radiation, or lithographic means.

To use the hologram efficiently, there should be as much overlap of the input and output light cones as possible. To provide this, the distance between input and output points \vec{r}₁, and \vec{r}₂ on FIG. 1 should be much less than \vec{r}. For large distances from the input and output points, segments of ellipses are very close to straight lines such that equation (2), can be equally applicable to the curved holograms as well. Additionally, for very large elliptical structures, these structures approximate straight lines and the distance between the elliptical structures should be the same as for the straight line structures (e.g., λ/2). Curved (elliptic) hologram lines may add compexity in manufacturing, but have the advantage of providing focusing properties.

Similar to the one-dimensional case, wavelength selectivity for two-dimensional planar thick holograms is related to a modulation function. As used when modifying hologram(s), it is noted the term “thick” does not refer to the planar waveguide physical thickness, but rather it relates to the great (increased) length the light travels along the hologram in the plane of the planar waveguide. For the simplest (comprising not elliptic, but straight lines) two-dimensional planar hologram, the refraction index modulation can be described as

δn(\vec{r})=Δn·(1+f_{slow}(\vec{r})·cos(\vec{q}·\vec{i})) (6)

where \vec{r} is the two-dimensional radius vector, and \vec{q} is the wave vector of a given hologram.

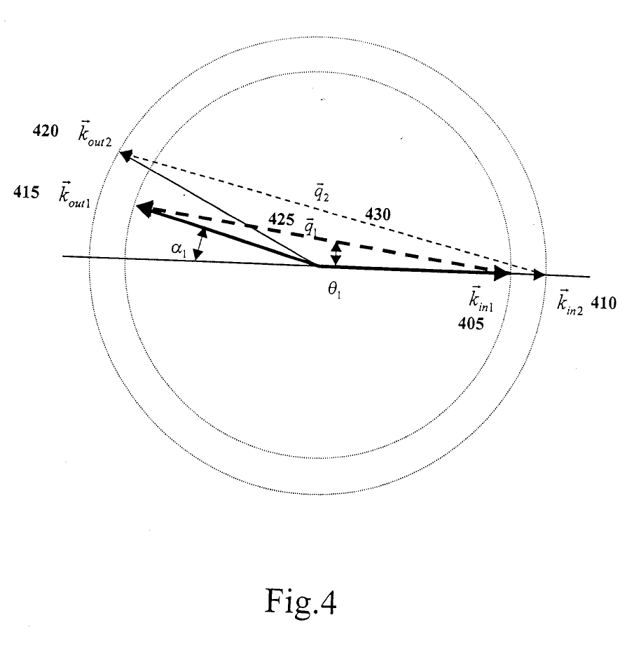

The relationship between hologram wave vectors 425, 430 (\vec{q}₁,\vec{q}₂), the input light wave vectors 405, 410 (\vec{k}ₘ₁,\vec{k}ᵢₙ₂), and the output light wave vectors 415, 420 (\vec{k}ₒᵤₜ,\vec{k}ₒᵤₜ₂) is shown in FIG. 4. The purpose of a demultiplexer is to separate light waves of different wavelengths, which initially propagate all together, so all input wave vectors are parallel. Additionally, as shown in FIG. 4, to separate light of different wavelengths at the output for efficient demultiplexing, the output wave vectors \vec{k}ₒᵤₜ₁,\vec{k}ₒᵤₜ₂, . . . may form different angles α₁,α₂, . . . with direction of initial light propagation.

Since the light frequency does not change after diffraction, the absolute value of the wave vector for the input or output optical beams does not change either. Only the direction for the wave vector changes such that, as shown in FIG. 4, the input and output wave vectors for some particular wavelength must be on the same circle. For the wave with wave vector \vec{k}ₒᵤₜ to form an angle a with \vec{k}ᵢₙ, as shown in FIG. 4, there must exist Bragg vector \vec{q} with absolute value

q=2kᵢₙ·cos(α/2)

This Bragg vector \vec{q} must form angle

θ=α/2

with the initial direction of light plane waves propagation, as shown in FIG. 4 for each input and output wave vector (θ₁, θ₂, α₁, α₂).

For commercial WDM communication systems, the values of wave vectors

kᵢₙ₁=2πn/λ₁,kᵢₙ₂=2πn/λ₂, . . .

(kᵢₙ₁, kᵢₙ₂, . . . ) may be defined by the standard values of wavelengths λ₁,λ₂, . . . , used in communication networks, and by the effective refractive index n of the planar waveguide, and the deflection angles α₁,α₂, . . . may be adjusted to simplify the planar holographic multiplexer/demultiplexer design.

In accordance with the above-mentioned formulas, the known values of kᵢₙ₁,kᵢₙ₂, . . . and chosen values of α₁,α₂. . . unambiguously define the values and directions of the Bragg vectors \vec{q}₁,\vec{q}₂, . . . which preferably exist in the planar waveguide hologram, and are preferably written into the holographic element of the waveguide.

Advantageously, the holographic element is prepared such that one hologram represents one channel. Additionally, all the holograms with proper Bragg vectors \vec{q}₁,\vec{q}₂, . . . may be advantageously written into the planar waveguide (e.g., core or cladding layer) to form the holographic element. The entire holographic multiplexer/demultiplexer may be implemented as a planar lightwave circuit (PLC), that also may be referred as a photonic integrated circuit (PIC).

Each of the many holograms, written into the same waveguide, may have an individual value of Δn. So, the width of a selectivity curve (including region of bandpass for center wavelength, λ_{c}) for any given channel may be chosen arbitrary at the design time. The direction of deflection is completely independent from the channel bandwidth, and is defined by the value and direction of the vector \vec{q} for the corresponding hologram.

The light speed in the optical fiber depends on frequency, the phenomenon known as chromatic dispersion, leading to the variation of arrival time for different frequencies and a signal distortion. To diminish the signal distortion, optical fiber communication systems frequently use dispersion compensators, which compensate linear dispersion or dispersion slope or both. Well-known devices for the dispersion compensation include fiber Bragg gratings with varying period. As a result of the period variation, the light of different frequencies reflects at different distances, thus providing time delay and dispersion compensation. The holographic multiplexer/demultiplexer wherein the holograms are formed by elliptical or linear structures also could be made with varying period to compensate for chromatic dispersion or dispersion slope. That method provides simultaneous multiplexing/demultiplexing and dispersion compensating in one device, thus reducing the insertion loss and the manufacturing cost.

All holograms, consisting of straight lines (FIG. 3), or of ellipses (FIG. 1), may be created by a wide variety of methods. We may divide these methods into 3 groups:

1) Direct writing by interference pattern of two coherent radiation beams

2) Direct writing by focused beam of some kind of radiation

3) Lithographic methods or any microtechnology

Advantageously for all cases, planar waveguide design, unlike three-dimensional (3D) volume hologram design, provides easy side access to all points of the planar waveguide, in which the holograms should be created.

The planar waveguide holograms by may be written as an interference pattern of two optical beams, each carrying ultraviolet (UV) radiation. Advantageously, the planar waveguide is comprised of silica, and germanium or another substance sensitive to UV to form the desired structures by varying the refractive index of the waveguide.

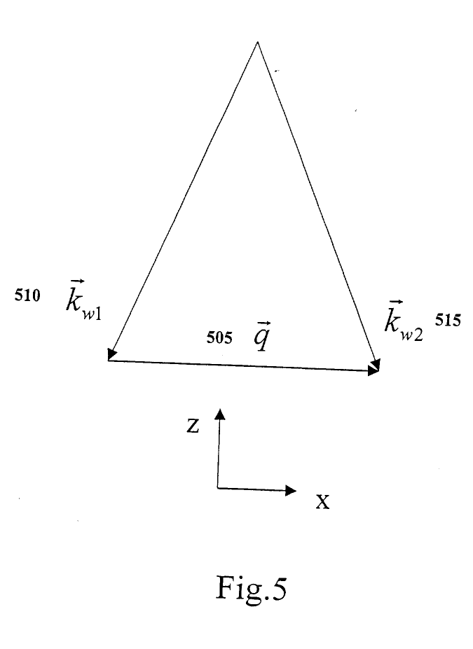

FIG. 5 is an illustration showing the relationship between the hologram wave vector 505 and the wave vectors 510, 515 for the writing optical beams in accordance with an embodiment of the present invention. As shown in FIG. 5, in a three-dimensional coordinate system where the z-axis is in the direction of cladding/core depth, the writing radiation propagates in the z-direction. The difference between the two wave vectors 510, 515 (k_{w1},k_{w2}) is equal to the hologram wave vector \vec{q}. Additionally, \vec{q} is perpendicular to the straight line vectors comprising the plurality of holograms written in to the holographic element. The writing radiation propagates only a short distance (thickness of the planar waveguide and cladding layer in the z-direction) inside the hologram material. In contrast to three-dimensional holograms, absorption of the writing radiation in the planar hologram does not spoil the planar hologram quality because of side access to the waveguide.

FIG. 5 can be advantageously used to create holograms, consisting of straight lines (as shown in FIG. 3). However, a more advanced optical system may be used to deform wavefronts of writing interfering (optical) beams in such a way that they will produce elliptically curved interference lines as shown in FIG. 1. Thus, elliptic holograms also may be written by two interfering beams of UV radiation.

Additionally, the refractive index may be varied by irradiation of the waveguide by visible light (using a waveguide made of light-sensitive glass), electron beams, and other sources of radiation. Also, light sensitive polymers may be used to write the structures to vary the refractive index. Ion implantation can be used to modulate refraction index of the planar waveguide hologram.

An alternative method for providing effective refractive index modulation δn(x) is not to physically change the refractive index in the planar waveguide, but to change the thickness of either of waveguide or cladding. For example, in the case of straight line holograms (FIG. 3), for each separate hologram with vector \vec{q} such thickness change should have periodicity in the x-y plane, defined by the vector \vec{q}. The thickness modulation amplitude z(x) may follow the law:

δz(x)=Δz·(1+f_{slow}(x)·cos(q·x)) (7)

where x is waveguide plane coordinate along the vector \vec{q}.

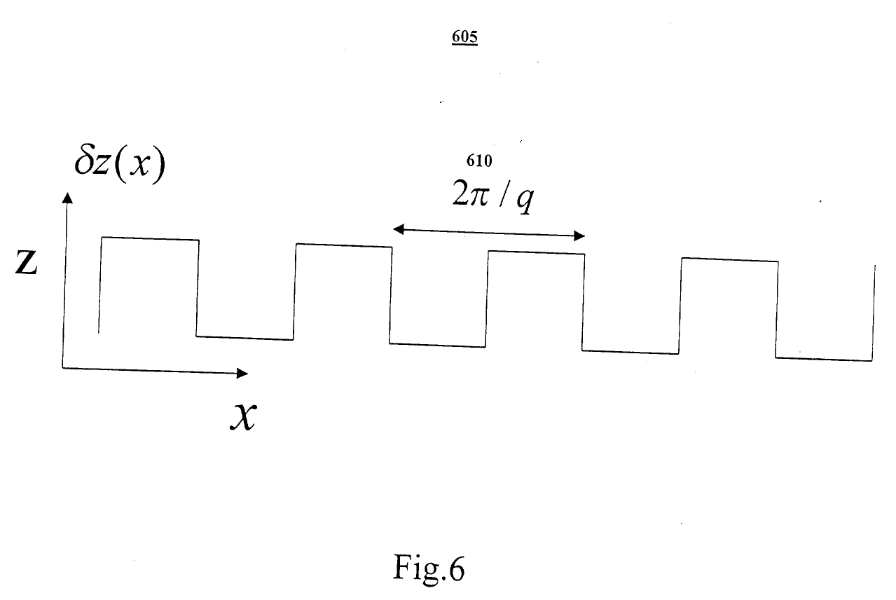

The simple cosine shape of periodic modulation may not be critical for efficient multiplexing/demultiplexing operation. Any periodic function of x with period 2π/q along the vector \vec{q} direction may be sufficient. FIG. 6 is an illustration, showing an exemplary rectangular shape instead of a cosine shape, of a periodic thickness modulation 605 (z-axis is the direction of thickness for the waveguide) with period 610 (2π/q) for a hologram in accordance with an embodiment of the present invention. Such rectangular shape may be used and may be easier to realize by lithographic methods.

A number of imprinting and lithographic techniques can also be employed in the preparation of the holographic element to create the structures by varying the thickness of the waveguide. Such techniques include, among others, laser burning, ion-implantation that varies the refraction index of the holographic element, micro-printing, micro-inkjet printing, laser-beam lithography, electron-beam lithography, and ion-beam lithography. These techniques can be used to simulate the structures created by using a photographic method.

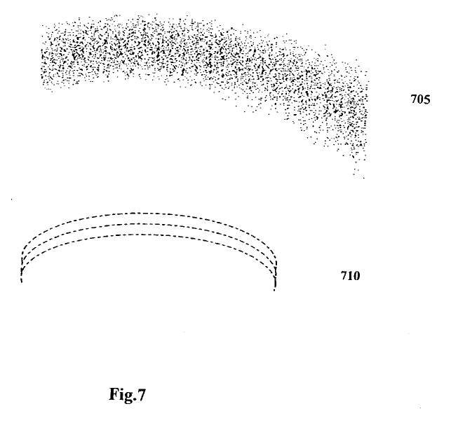

To simplify manufacturing of overlapping planar waveguide holograms by lithographic methods, an alternative embodiment for the planar waveguide holograms is shown in FIG. 7. As shown in FIG. 7, the superposition of solid (straight) or elliptical lines by a dashed 710 or dotted structure 705 may be used to form the elliptical holograms. The long path of light in the planar holographic element allows use of these weakly reflecting structures, comprising bi-level holograms written in a reduced number of lithographic procedures. The holograms may be written using a number of methods which include, but are not limited to, a lithographic method using data generated by a computer and other methods. Also, advantageously using both complex and bi-level structures allows constructive interference of light waves reflected from a single element to several focal points.

Using lithographic or laser burning methods, the dashed or dotted structure 705, 710 may be formed as a binary hologram (binary relief). Also, advantageously, these holograms may be created as a set of rectangular regions where the centers of the regions may be placed at the maxima or minima of a refractive index modulation. To diminish the overlapping of holograms, the dashed or dotted structures 705, 710 may be rarified, and the spacing between the dashes may vary to fit the reflection coefficient of the structures and reduce destructive interference (cross-talk). Similar to FIGS. 1 and 3, the structures of FIG. 7 provide effective multiplexing/demultiplexing by reflecting pre-determined light wavelengths from an input optical beam.

Additional problems may affect the performance of a planar waveguide holographic multiplexer/demultiplexer as described herein. Planar waveguides are polarization sensitive due to the different effective index for transverse electric (TE) and transverse magnetic (TM) modes, the phenomenon also known as birefringence. Polarization sensitivity leads to signal distortion. If the distortion cannot be avoided, then it should be minimized. There are two opposing methods to achieve signal distortion reduction by diminishing polarization sensitivity.

The first method is to design a planar waveguide with small birefringence, which may be achieved by using core and claddings with small difference of refraction index and/or combining layers to compensate birefringence induced by different boundaries. The second method for diminishing polarization sensitivity is to design a planar waveguide with a big difference of effective index for TE and TM modes, so that separate holograms could be written for TE and TM modes. Due to the big difference in effective index; TE modes do not resonate with TM holograms, and TM modes do not resonate with with TE holograms.

A number of further advantages may be realized for the planar holographic multiplexer in accordance with embodiments of the present invention. This may include increasing the number of demultiplexed channels and simplifying manufacturing by writing the holograms for different channels in different parts of the planar waveguide, along the input light propagation path.

Additionally, to increase operating options, the single incoming fiber of demultiplexer (outgoing fiber of multiplexer) could be substituted by several fibers. That allows an exchange of channels between fibers in different combinations.

In accordance with embodiments of the present invention, numerous advantages are obtained from the planar holographic multiplexer/demultiplexer as described herein. These advantages include increased wavelength selectivity, reduced signal distortion, reduced light loss upon reflection, and easier manufacturing produced from easy side access to the planar waveguide.

Additionally, the planar holographic multiplexer/demultiplexer could be integrated with other planar devices, including interleavers, in Photonic Integrated Circuits, also known as Planar Lightwave Circuits. The material of the planar holographic multiplexer/demultiplexer may be glass or semiconductor for easier integration with active opto-electronic devices including, but not limited to, lasers, optical amplifiers, attenuators and switches.

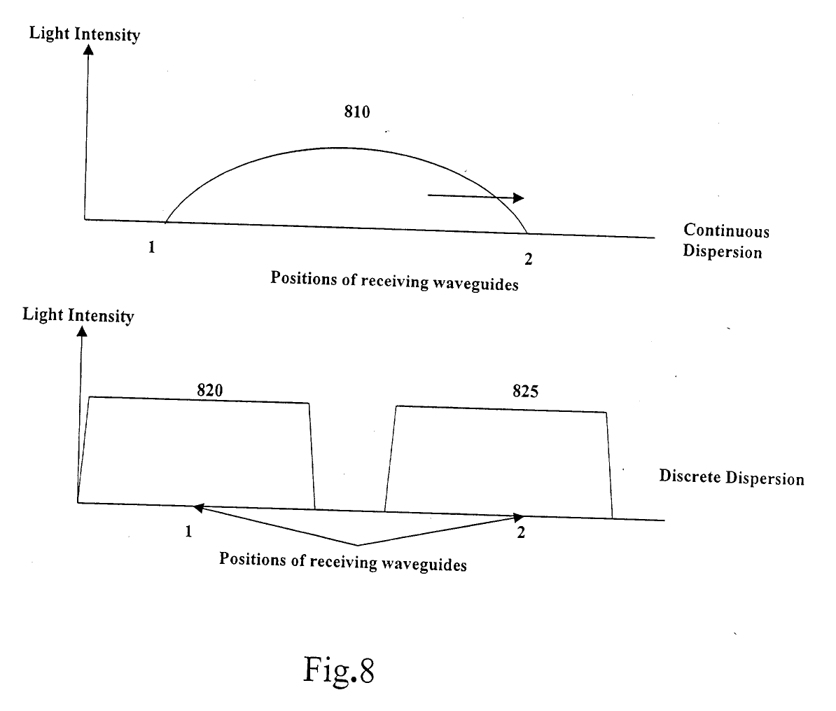

The reduced signal distortion and improved light efficiency are consequences of the discrete dispersion created by the planar holographic multiplexer/demultiplexer. FIG. 8 is an illustration of discrete dispersion produced by the holographic multiplexer/demultiplexer in accordance with an embodiment of the present invention. As shown; in FIG. 8, the planar holographic multiplexer/demultiplexer selectively reflects a first center wavelength 820 and a second center wavelength 825 at two distinct receiving waveguide positions (focal points). There is substantial light intensity falloff between focal points (center wavelengths) to significantly reduce signal distortion. In contrast, a traditional mutliplexer/demultiplexer, including AWG or etched gratings, using continuous dispersion 810 has no light intensity falloff between focal points which creates substantial signal distortion.

FIG. 8 also shows the flat top of the holographic multiplexer/demultiplexer in accordance with an embodiment of the present invention. The substantially rectangular shape of the curve is formed with increased (nearing 100%) reflectivity within a bandpass regions 820 and 825, and reduced (nearing 0%) reflectivity outside of the bandpass regions. The width of the flat tops of FIG. 8 is given by equation (5). It is important that multiple reflections in the exemplary holographic element, as described herein, lead to increased (high) light efficiency and improved wavelength selectivity.

As a practical application, the planar holographic multiplexer/demultiplexer described herein may be used in an optical communications system further including a variety of interconnected components such as electro-optic components, optical switches and couplers, optical transmission media, and other components for delivering communications services to a plurality of users.

Although the invention is described herein using a two-dimensional planar hologram as the primary holographic element for the holographic multiplexer/demultiplexer, it will be appreciated by those skilled in the art that modifications and changes may be made without departing from the spirit and scope of the present invention. As such, the method and apparatus described herein may be equally applied to any superposition of holograms that provides for optical multiplexing/demultiplexing when irradiated by a optical beam using a planar waveguide.

What is claimed is:

1. A planar holographic multiplexer/demultiplexer, comprising:
a planar waveguide wherein light traveling within the waveguide propagates in two-dimensional space; and
wherein the planar waveguide includes a holographic element written with a plurality of holograms, each hologram reflecting a pre-determined light wavelength.

2. The holographic multiplexer/demultiplexer according to claim 1, wherein the holograms are formed by elliptical structures and the pre-determined light wavelengths are reflected to corresponding focal points.

3. The holographic multiplexer/demultiplexer according to claim 2, wherein the plurality of elliptical structures include elements common for different holograms to increase the diffraction efficiency.

4. The holographic multiplexer/demultiplexer of claim 2, wherein the plurality of elliptical structures are substantially bi-level structures.

5. The holographic multiplexer/demultiplexer of claim 4, wherein the plurality of bi-level structures are at least one of dashed or dotted structures.

6. The holographic multiplexer/demultiplexer of claim 1, wherein the holograms are linear structures and at least one lens is provided for focusing the reflected pre-determined wavelengths to corresponding focal points.

7. The holographic multiplexer/demultiplexer of claim 6, wherein the lens is a graded index lens.

8. The holographic multiplexer/demultiplexer of claim 7, wherein the lens is generated using either of non-homogenous ultraviolet radiation or visible light radiation.

9. The holographic multiplexer/demultiplexer of claim 7, wherein the lens is generated using lithographic means.

10. The holographic multiplexer/demultiplexer of claim 1, wherein the holographic element is photosensitive and the hologram is written as an interference pattern of at least two optical beams.

11. The holographic multiplexer/demultiplexer of claim 10, wherein the optical beams carry ultraviolet radiation.

12. The holographic multiplexer/demultiplexer of claim 1, wherein the holographic element is photosensitive and the hologram is generated from a focused optical radiation beam.

13. The holographic multiplexer/demultiplexer of claim 1, wherein the holographic element is generated using non-photographic means.

14. The holographic multiplexer/demultiplexer of claim 13, wherein the non-photographic means includes electron-beam lithography.

15. The holographic multiplexer/demultiplexer of claim 13, wherein the non-photographic means includes ion-beam lithography.

16. The holographic multiplexer/demultiplexer of claim 13, wherein the non-photographic means includes laser-beam lithography.

17. The holographic multiplexer/demultiplexer of claim 13, wherein the non-photographic means includes micro-printing.

18. The holographic multiplexer/demultiplexer of claim 13, wherein the non-photographic means includes micro-jet printing.

19. The holographic multiplexer/demultiplexer of claim 13, wherein the non-photographic means includes laser burning.

20. The holographic multiplexer/demultiplexer of claim 13, wherein the non-photographic means includes ion implantation, the ion implantation varying the refraction index of the holographic element.

21. The holographic multiplexer/demultiplexer of claim 1, wherein the plurality of holograms form a plurality of superposed holograms, each hologram reflecting a different pre-determined light wavelength.

22. The holographic multiplexer/demultiplexer of claim 21, wherein the holographic element produces discrete dispersion of a plurality of reflected pre-determined light wavelengths.

23. The holographic multiplexer/demultiplexer of claim 1, wherein the plurality of holograms are formed by varying pre-determined optical properties of the planar waveguide.

24. The holographic multiplexer/demultiplexer of claim 23, wherein the optical properties include refractive index of at least one of core or cladding layer of the planar waveguide.

25. The holographic multiplexer/demultiplexer of claim 23, wherein the optical properties include thickness of at least one of core or cladding layer of the planar waveguide.

26. The holographic multiplexer/demultiplexer of claim 1, wherein the holographic element produces a selectivity curve with increased reflectivity within a bandpass region including the predetermined light wavelength, and reduced reflectivity outside of the bandpass region.

27. The holographic multiplexer/demultiplexer of claim 26, wherein the selectivity curve forms a substantially rectangular shape for a region including the bandpass region.

28. The holographic multiplexer/demultiplexer of claim 1, further comprising:
a plurality of optical fibers including tips that perform at least one of transmitting an optical beam containing the pre-determined light wavelength to the holographic element, and receiving the reflected pre-determined light wavelength.

29. A method of demultiplexing an optical beam, comprising:
receiving an optical beam using a planar waveguide, the planar waveguide including a holographic element;
reflecting pre-determined light wavelengths of the optical beam using the holographic element, the holographic element being written with a plurality of holograms, each reflecting a pre-determined light wavelength.

30. The method of claim 29, wherein the plurality of holograms form a plurality of superposed holograms, each hologram reflecting a different pre-determined light wavelength.

31. A method of multiplexing a plurality of optical beams, comprising:
receiving a plurality of optical beams using a planar waveguide, the planar waveguide including a holographic element;
reflecting a different pre-determined light wavelength for each optical beam using the holographic element to form a single optical beam, the holographic element being written with a plurality of holograms, each reflecting a different pre-determined light wavelength.

32. The method of claim 31, wherein the plurality of structures form a plurality of superposed holograms, each hologram reflecting a different pre-determined light wavelength.

33. The holographic multiplexer/demultiplexer of claim 1, wherein the holograms are formed by elliptical or linear structures with varying period to compensate for either of chromatic dispersion, dispersion slope, or chromatic dispersion and dispersion slope to provide simultaneous multiplexing/demultiplexing and dispersion compensating.

34. The holographic multiplexer/demultiplexer of claim 1, wherein the plurality of holograms includes at least one pair of holograms, one hologram of the pair corresponding to a transverse electric mode and the other hologram corresponding to a transverse magnetic mode, to reduce polarization dependency loss in the waveguide.

35. A planar photonic integrated circuit, comprising:
a planar waveguide wherein light traveling within the waveguide propagates in two-dimensional space;
wherein the planar waveguide includes a holographic element written with a plurality of holograms, each hologram reflecting a pre-determined light wavelength; and
wherein the holographic element is formed using semiconductor materials.

36. An optical communications system, comprising:
a holographic multiplexer/demultiplexer including:
a planar waveguide;
wherein the planar waveguide includes a holographic element written with a plurality of structures to reflect a pre-determined light wavelength;
at least one opto-electronic component; and
at least one optical transmission medium, interconnected to the opto-electronic component and the holographic multiplexer/demultiplexer, for delivering communications services to a user.

37. The optical communications system of claim 36, wherein the plurality of structures form a plurality of superposed holograms, each hologram reflecting a different pre-determined light wavelength.

38. An optical apparatus, comprising:
a planar waveguide wherein light traveling within the waveguide propagates in two-dimensional space; and
wherein the planar waveguide includes a holographic element written with a plurality of holograms.
